(19) United States
(12) Patent Application Publication
(10) Pub. No.: US 2015/0125577 A1
(43) Pub. Date: May 7, 2015

(54) TUBER STORAGE TEST METHODS

(71) Applicant: REGENTS OF THE UNIVERSITY OF MINNESOTA, Minneapolis, MN (US)

(72) Inventor: Sanjay K. Gupta, New Hope, MN (US)

(21) Appl. No.: 14/535,634

(22) Filed: Nov. 7, 2014

Related U.S. Application Data
(60) Provisional application No. 61/901,142, filed on Nov. 7, 2013.

(51) Int. Cl. A23B 7/04

(52) U.S. Cl. CPC A23B 7/04; A23V 2002/00
USPC 426/231

(57) ABSTRACT

This disclosure provides a method useful for identifying tubers (e.g., potatoes) suitable for long-term cold storage. Generally, the method includes analyzing a plurality of potatoes for at least one cold storage indicator, and storing at least a portion of the plurality of potatoes for a predetermined time at a predetermined temperature if the cold storage indicator value is a predetermined value.

### CROSS-REFERENCE TO RELATED APPLICATION

This application claims priority to U.S. Provisional Patent Application Ser. No. 61/901,142, filed Nov. 7, 2013, which is incorporated herein by reference.

### SUMMARY

This disclosure provides a method useful for identifying tubers (e.g., potatoes) suitable for long-term cold storage. Generally, the method includes analyzing a plurality of potatoes for at least one cold storage indicator, and storing at least a portion of the plurality of potatoes for a predetermined time at a predetermined temperature if the cold storage indicator value is a predetermined value.

In some embodiments, the predetermined time is no more than 270 days.

In some embodiments, the predetermined temperature is no more than 45° F.

In some embodiments, the cold storage indicator can be acid invertase and/or the A-II isozyme of UGPase.

In some embodiments, the stored potatoes possess an average glucose forming potential of no more than 1.50.

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE FIGURES

FIG. 1. Data showing properties of acid invertase activity over time.

FIG. 2. Data showing properties of acid invertase activity over protein concentration.

FIG. 3. Data showing the relationship between acid invertase activity and glucose:sucrose ratio.

FIG. 4. Data showing the relationship between basal acid invertase activity and glucose forming potential (GFP).

FIG. 5. Data showing the relationship between total acid invertase activity and glucose forming potential (GFP).

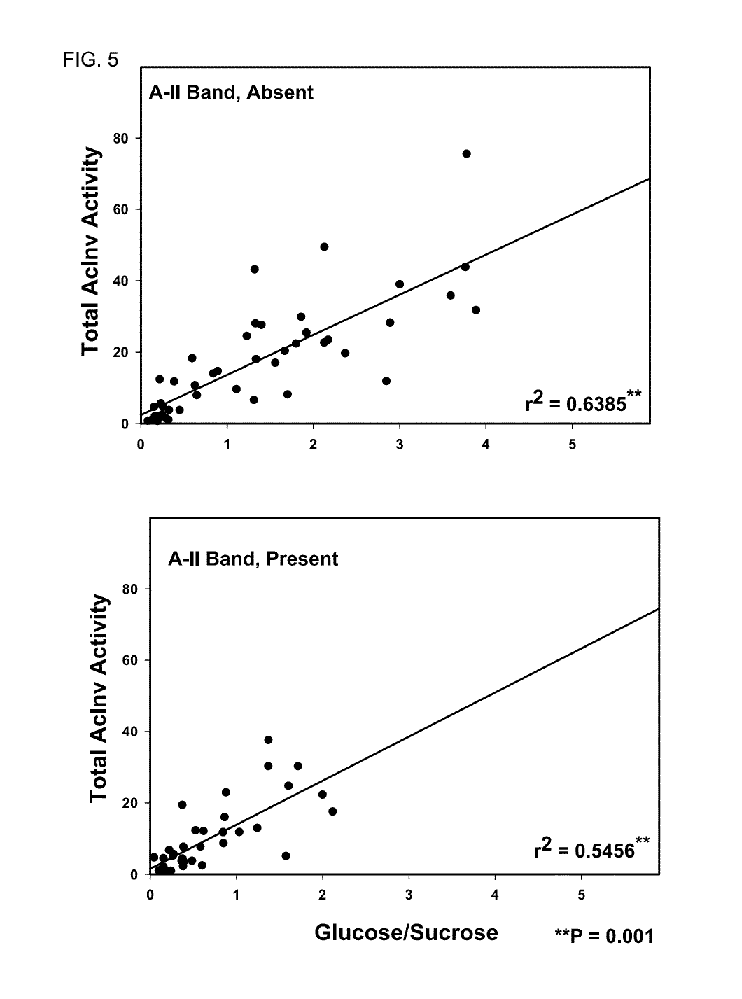

### DETAILED DESCRIPTION OF ILLUSTRATIVE EMBODIMENTS

This disclosure describes new technology to predict the storability of potatoes for long-term cold storage. During long-term cold storage, potatoes can accumulate high levels of reducing sugars. Potatoes with high levels of reducing sugars can produce food products (e.g., French fries and/or potato chips) with dark color and/or an off taste. High levels of accumulated reducing sugars also can result in the production of greater amounts of acrylamide during processing and/or cooking

Thus, this disclosure describes a method for identifying potatoes suitable for long-term cold storage. Generally, the method includes analyzing a plurality of potatoes for at least one cold storage indicator, and storing at least a portion of the plurality of potatoes for a predetermined time at a predetermined temperature if the cold storage indicator value is a predetermined value.

Invertases (e.g., EC 3.2.1.26, β-fructosidase, β-fructofuranosidase) catalyze hydrolysis of sucrose to the reducing sugars glucose and fructose as shown in Formula (I):

Suc+H₂O→Glc+Fru (I)

Many acid invertases can be inhibited by hexose sugars such as, for example, fructose. Invertase inhibitors have been reported in potato tubers, red beet, sugar beet, sweet potato, and in maize endosperm. Invertase inhibitors are soluble proteins and regulate, at least in part, whose acid invertase enzymatic activity. For example, vacuolar acid invertase (VAcInv) activity is determined, at least in part, by the balance between the enzyme and its corresponding inhibitor. It is currently unclear, however, how control of VAcInv activity by invertase inhibitors is regulated (Chen et al. 2008. Plant Cell Environ. 31:165-176).

Currently, there is no reliable method that can predict the reducing sugar accumulation in potatoes during long-term cold storage. The methods described herein can permit potato growers, brokers, and/or food producers to better identify varieties of potatoes best suited for food production and/or long-term cold storage.

As used herein, “long-term cold storage” refers to storing potatoes at a predetermined temperature for a predetermined length of time. The predetermined temperature may be any suitable temperature for storing potatoes for a particular predetermined length of time. In some embodiments, the predetermined temperature may be a maximum temperature of no more than 55° F. such as, for example, no more than 52° F., no more than 50° F., no more than 45° F., no more than 42° F., no more than 40° F., or no more than 38° F. In some embodiments, the predetermined temperature may be a minimum temperature of no less than 33° F., no less than 34° F., no less than 35° F., no less than 36° F., no less than 37° F., no less than 38° F., or no less than 40° F. The predetermined range also can be expressed as a range having endpoints defined by any minimum predetermined temperature listed above and any maximum predetermined temperature that is greater than the minimum predetermined temperature. In some embodiments, therefore, the predetermined temperature may be from 40° F. to 45° F.

The predetermined length of time may be any length of time appropriate for storing potatoes. In some embodiments, the predetermined length of time may be a minimum of at least 14 days such as, for example, at least 30 days, at least 45 days, at least 60 days, at least 90 days, at least 120 days, at least 150 days, at least 180 days, at least 210 days, or at least 240 days. In some embodiments, the predetermined length of time may be a maximum of no more than 365 days such as, for example, no more than 270 days, no more than 240 days, no more than 210 days, no more than 180 days, no more than 150 days, no more than 120 days, no more than 90 days, no more than 60 days, no more than 45 days, or no more than 30 days. The predetermined length of time also can be expressed as a range having endpoints defined by any minimum length of time listed above and any maximum length of time greater than the minimum length of time. In some embodiments, therefore, the predetermined length of time may be from 45 days to 270 days.

The cold storage indicator may be any biological substance and/or activity that correlates with reducing the glucose forming potential (GPF, (glucose/sucrose)) in potatoes during long-term cold storage. In some embodiments, the glucose forming potential may be no more than 5 such as for example, no more than 4, no more than 3, no more than 2.5, no more than 2.0, no more than 1.5, no more than 1.0, no more than 0.8, no more than 0.5, or no more than 0.3.

Thus, one may analyze a sample for the presence of the cold storage indicator in, for example, and extract prepared from a sample of potatoes. The level of the cold storage indicator may involve separating the cold storage indicator from other components of the sample by conventional separation methods such as electrophoresis, filtration, dialysis, and or chromatography, followed by visualizing the cold storage indicator. In other embodiments, the presence of the cold storage may involve an assay to detect and/or quantify enzymatic activity of the cold storage indicator.

In some embodiments, the predetermined value may be the qualitative presence of the indicator in the sample. In other embodiments, the predetermined value may be a quantitative measure of the amount of the cold storage indicator in a sample (e.g., mass, concentration) or the activity (e.g., enzymatic activity) of the cold storage indicator in the sample.

In some embodiments, the cold storage indicator may be acid invertase, the A-II isozyme of UGPase, or a combination of both. In embodiments in which the cold storage indicator includes acid invertase, and the predetermined value can be no more than 3 enzyme units (μmols glucose formed/mg protein/hour) such as, for example, no more than 2 enzyme units, no more than 1 enzyme unit, or no more than 0.5 enzyme units. In embodiments, in which the cold storage indicator includes the A-II isozyme of UGPase, the predetermined value can reflect the qualitative presence of the isozyme.

### Acid Invertase Assay Standardization

This protocol was standardized for linearity of reaction with enzyme dilution (protein concentration) and reaction time.

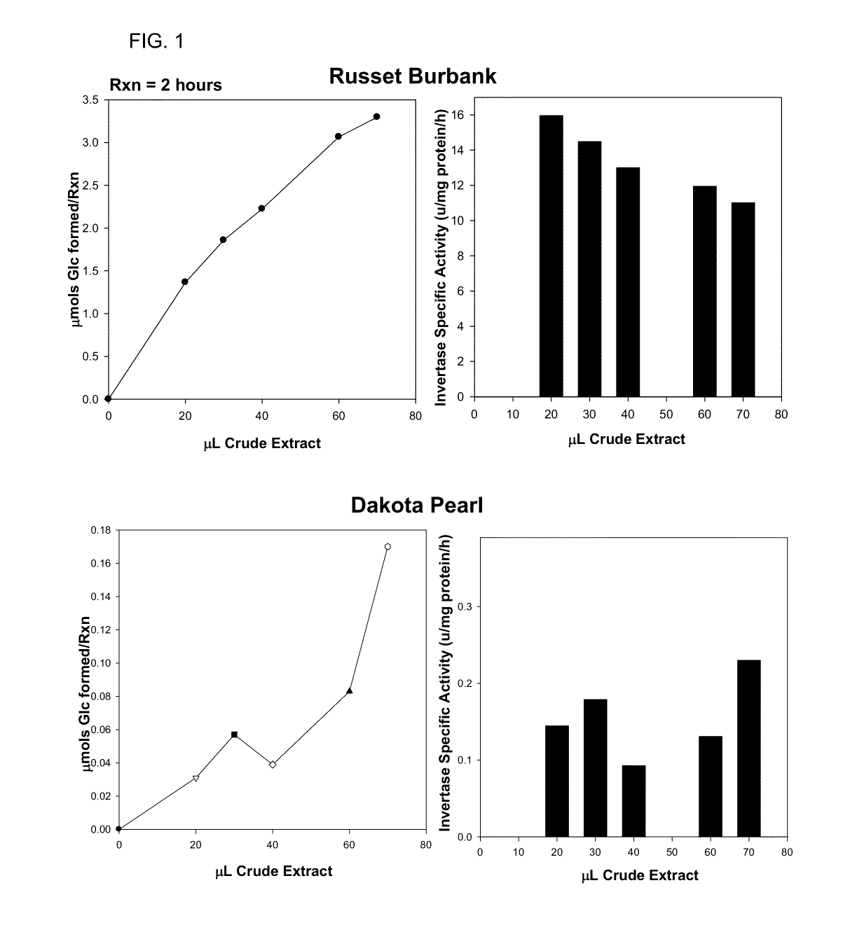

FIG. 1 shows that acid invertase activity is generally linear between 20 μL to 60 μL of crude extract (88.8 μg to 266.4 μg protein per reaction) in the case of Russet Burbank (RB) and between 30 μL to 70 μL (293.16 μg to 684.04 μg protein per reaction) for cultivar Dakota Pearl (DP). The specific activity for RB was around 14.5 μmols glc/mg protein/hour and was constant with enzyme dilution. For DP, Specific activity was around 0.1 μmols glc/mg protein/hour, which increased up to around 0.23 μmols glc/mg protein/hour with 70 μL crude extract.

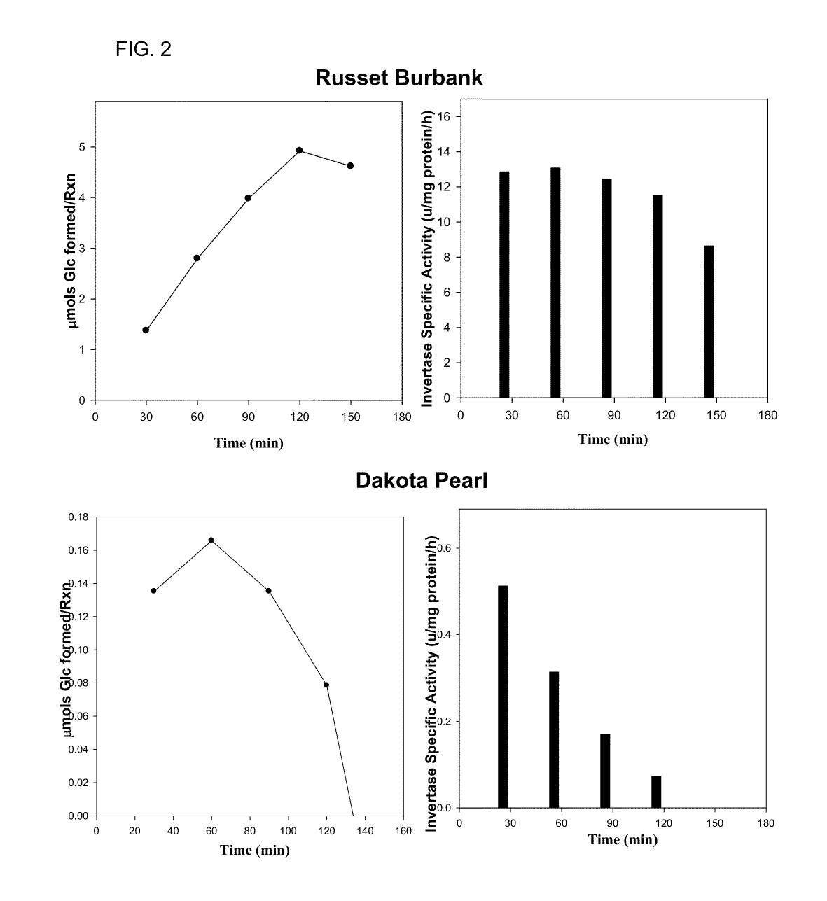

Based on the data in FIG. 1, we chose 50 μL crude extract as a representative model protein concentration for subsequent assays. To check the time dependence of acid invertase activity, we used 50 μL crude extract to run the reaction at 37° C. for 30 minutes, 60 minutes, 90 minutes, 120 minutes, or 150 minutes. FIG. 2 shows that the invertase enzyme activity and specific activity was linear up to 120 minutes in the Russett Burbank. For the cultivar DP, the basal acid invertase activity increased up to 60 minutes, but then declined. A similar pattern was observed with respect to specific activity.

A-II isozyme of UGPase

155 potato cultivars were screened for the presence or absence of enzymatic activity of the A-II isozyme of UGPase. Of the 155 lines, 74 cultivars exhibit A-II isozyme activity.

The 155 cultivars and clones were divided into two groups based on the presence or absence of the A-II isozyme of UGPase. Each group was further subdivided into subgroups based on its basal acid invertase (AcInv) activity. One subgroup, designated A-1, included cultivars with no A-II isozyme and basal acid invertase activity of less than 1 unit. A second subgroup, designated A-2, included cultivars with no A-II isozyme and basal acid invertase activity between 1 unit and 3 units. A third subgroup, designated A-3, included cultivars with no A-II isozyme and a basal acid invertase activity of more than 3 units. The subgroup designated B-1 included cultivars with the A-II isozyme and less than 1 unit basal acid invertase activity. The subgroup designated B-2 included cultivars with the A-II isozyme and a basal acid invertase activity of between 1 unit and 3 units. Finally, the subgroup designated B3 included cultivars with A-II isozyme and more than 3 unit of acid invertase activity.

Table 1 summarizes data from the subgroup of 40 potato cultivars designated A-1. Average basal acid invertase activity in this group was 0.46 and the total acid invertase activity in this group was 10.12 units/hour. Average sucrose and glucose content were 3.04 and 1.70 mg/g fresh weight, respectively. The average glucose forming potential (GFP, i.e., glucose:sucrose ratio) was 0.56 and total sugar was 4.74 mg/g fresh weight.

TABLE 1
Potato cultivars without A-II isozyme of UGPase and
less than 1 unit of basal acid invertase activity.

| | Basal | Total | | | Suc + | |
|---|---|---|---|---|---|---|
| Cultivar | AcInv¹ | AcInv¹ | Suc² | Glc² | Glc | GFP |
| A 95109-1 | 0.94 | 18.11 | 1.83 | 4.16 | 5.99 | 2.28 |
| AF 2215-1 | 0.22 | 16.88 | 3.12 | 1.64 | 4.75 | 0.53 |
| AF 2916-1 | 0.71 | 24.70 | 5.19 | 3.37 | 8.56 | 0.65 |
| AOA 95154-1 | 0.42 | 11.70 | 1.52 | 4.34 | 5.86 | 2.85 |
| Atlantic | 0.15 | 12.88 | 2.65 | 2.55 | 5.21 | 0.96 |
| B 2489-4 | 1.00 | 10.56 | 2.37 | 1.50 | 3.87 | 0.63 |
| CO 96052-1RU | 0.01 | 3.58 | 5.15 | 1.71 | 6.86 | 0.33 |
| CO 97043-14W | 0.34 | 1.86 | 4.15 | 0.70 | 4.85 | 0.17 |
| CO 97065-7W | 0.41 | 1.29 | 6.19 | 1.85 | 8.04 | 0.30 |
| CV 98112-3 | 0.08 | 2.29 | 7.90 | 1.99 | 9.89 | 0.25 |
| Dakota Diamond | 0.14 | 6.98 | 3.55 | 1.76 | 5.32 | 0.50 |
| Dakota Pearl | 1.00 | 6.43 | 3.27 | 4.31 | 7.59 | 1.32 |
| Iris Cobbler | 0.16 | 9.45 | 3.61 | 4.03 | 7.64 | 1.12 |
| MN 02 510 | 0.38 | 44.56 | 2.59 | 2.42 | 5.01 | 0.94 |
| MN 02 586 | 0.52 | 3.60 | 3.15 | 1.44 | 4.59 | 0.46 |
| MN 02 696 | 0.56 | 4.77 | 2.15 | 0.44 | 2.59 | 0.20 |
| MSJ 126-9Y | 0.15 | 5.49 | 3.10 | 0.74 | 3.84 | 0.24 |
| MSJ 316-A | 0.16 | 4.98 | 2.50 | 2.46 | 4.95 | 0.98 |
| MSK 061-4 | 0.20 | 0.75 | 4.11 | 0.52 | 4.63 | 0.13 |
| MSK 409-1 | 0.49 | 1.36 | 2.69 | 0.59 | 3.27 | 0.22 |
| N 8-14 | 0.15 | 0.54 | 2.61 | 0.52 | 3.13 | 0.20 |
| ND 5255-59 | 0.60 | 0.86 | 2.90 | 0.95 | 3.85 | 0.33 |
| ND 6095-1 | 0.93 | 13.99 | 2.70 | 1.16 | 3.85 | 0.43 |
| ND 7192-1 | 0.62 | 12.23 | 5.71 | 1.29 | 7.00 | 0.23 |
| ND 7519-1 | 0.10 | 10.22 | 1.35 | 0.59 | 1.93 | 0.44 |
| ND 7818-1Y | 0.03 | 15.90 | 2.47 | 1.10 | 3.58 | 0.45 |
| ND 8-14 | 0.77 | 13.25 | 3.21 | 1.15 | 4.36 | 0.36 |
| ND 8201-2 | 0.91 | 7.79 | 2.88 | 1.89 | 4.77 | 0.66 |
| ND 8304-2 | 0.52 | 10.11 | 1.58 | 1.39 | 2.97 | 0.88 |
| ND 860-2-8 | 0.70 | 5.86 | 2.42 | 0.81 | 3.23 | 0.33 |
| Pre. Russ (6LS) | 0.74 | 11.59 | 2.88 | 1.13 | 4.02 | 0.39 |
| Sport 860 | 0.98 | 14.02 | 2.10 | 0.53 | 2.63 | 0.25 |
| TX 1475-3W | 0.03 | 16.71 | 4.17 | 2.46 | 6.62 | 0.59 |
| W 2133-1 | 0.31 | 13.86 | 1.29 | 1.09 | 2.38 | 0.84 |
| W 2310-3 | 0.18 | 0.60 | 1.91 | 0.17 | 2.08 | 0.09 |
| W 2324-1 | 0.66 | 20.62 | 1.55 | 2.19 | 3.75 | 1.41 |
| W 2683-2 | 0.57 | 16.84 | 2.12 | 3.32 | 5.45 | 1.57 |
| W 2683-2 RUS | 0.93 | 17.03 | 1.92 | 2.46 | 4.37 | 1.28 |
| W 2978-3 | 0.35 | 4.53 | 3.49 | 0.92 | 4.41 | 0.26 |
| W 2982-1 | 0.28 | 5.94 | 1.72 | 0.34 | 2.07 | 0.20 |
| Average | 0.46 | 10.12 | 3.04 | 1.70 | 4.74 | 0.56 |

¹Specific Activity (SA) = units (mmols Glc formed)mg protein⁻¹hour⁻¹
²mg/g fresh weight (Suc + Glc)

Table 2 summarizes data from 24 cultivars in the subgroup designated A-2. The average basal and total acid invertase activity was 2.1 and 25.6 units/hour, respectively. Consistent with the invertase activity, members of this group exhibited higher glucose content (3.0 mg/g fresh weight) and glucose forming potential (1.25) and lower sucrose content (2.4 mg/g fresh weight).

TABLE 2
Potato clones without any A-II isozyme of UGPase
and 1-3 units of basal acid invertase activity.

| | Basal | Total | | | Suc + | |
|---|---|---|---|---|---|---|
| Cultivar | AcInv¹ | AcInv¹ | Suc² | Glc² | Glc | GFP |
| A 93157-6LS | 1.7 | 29.4 | 2.4 | 0.9 | 3.2 | 0.4 |
| A 96510-4Y | 2.6 | 25.3 | 2.5 | 4.8 | 7.2 | 1.9 |
| AF 2199-6 | 1.4 | 38.8 | 1.4 | 4.1 | 5.4 | 3.0 |
| AF 2413-4 | 1.1 | 22.5 | 1.9 | 4.1 | 6.0 | 2.1 |
| AOTX 95265-4ARU | 3.0 | 43.7 | 1.5 | 5.7 | 7.3 | 3.8 |
| ATTX 961014-1R/Y | 3.0 | 19.5 | 1.4 | 3.4 | 4.8 | 2.4 |
| ATTX 98500-2P/Y | 2.6 | 17.8 | 2.2 | 3.0 | 5.2 | 1.3 |
| B 2451-6 | 1.5 | 14.5 | 3.4 | 3.1 | 6.5 | 0.9 |
| B 2452-3 | 1.7 | 20.2 | 2.3 | 3.9 | 6.2 | 1.7 |
| Ivory Crisp | 2.0 | 12.3 | 2.3 | 2.3 | 4.6 | 1.0 |
| MN 02 515 | 1.4 | 31.1 | 1.4 | 4.2 | 5.6 | 3.1 |
| MSJ 036-A | 2.6 | 40.2 | 1.5 | 1.6 | 3.1 | 1.1 |
| MSK 061-4 | 1.0 | 10.9 | 4.7 | 1.0 | 5.7 | 0.2 |
| MSM 051-3 | 2.4 | 31.5 | 2.2 | 0.9 | 3.0 | 0.4 |
| ND 7519-1 | 1.8 | 1.9 | 1.6 | 0.3 | 1.9 | 0.2 |
| NDTX 8784-7R | 2.8 | 8.0 | 6.4 | — | — | — |
| R. Norland | 3.1 | 23.3 | 2.4 | 5.2 | 7.6 | 2.2 |
| Red Pontiac | 2.2 | 25.2 | 4.1 | 5.9 | 10.0 | 1.4 |
| RIO ROTO | 2.2 | 27.5 | 2.0 | 2.8 | 4.7 | 1.4 |
| VC 1009-1W/Y | 1.2 | 27.9 | 2.5 | 3.4 | 5.9 | 1.3 |
| W 2309-7 | 1.2 | 30.7 | 1.4 | 1.0 | 2.4 | 0.7 |
| W 2438-3 | 2.6 | 13.8 | 1.7 | 1.9 | 3.6 | 1.2 |
| W 2564-2 | 3.3 | 76.5 | 3.5 | 2.6 | 6.1 | 0.7 |
| WV 4298-1 | 1.6 | 22.2 | 1.9 | 3.4 | 5.3 | 1.8 |
| Average | 2.1 | 25.6 | 2.4 | 3.0 | 5.3 | 1.25 |

¹Specific Activity (SA) = units (mmols Glc formed)mg protein⁻¹hour⁻¹
²mg/g fresh weight (Suc + Glc)

Table 3 summarizes data from 15 cultivars in the subgroup designated A-3. The average basal and total acid invertase enzyme activity was 10.02 and 41.76 units per hour, respectively. Consistent with the higher basal acid invertase activity, these clones have high average glucose level of 5.38 mg/g fresh weight and glucose forming potential of 2.6. The average sucrose level in this was 2.07 mg/g fresh weight.

TABLE 3
Potato Clones without A-II isozyme of UGPase
and more than 3 units of Basal AcIv activity.

| | Basal | Total | | | Suc + | |
|---|---|---|---|---|---|---|
| Cultivar | AcInv¹ | AcInv¹ | Suc² | Glc² | Glc | GFP |
| A 9045-7 | 52.63 | 82.84 | 0.16 | 4.89 | 5.05 | 31.47 |
| AF 2290-8 | 13.498 | 75.389 | 1.900 | 7.190 | 9.090 | 3.784 |
| AOTX | 4.187 | 35.725 | 1.513 | 5.440 | 6.953 | 3.597 |
| 95265-2ARU | | | | | | |
| Chieftain | 5.86 | 19.51 | 0.96 | 7.22 | 8.18 | 7.55 |
| CvV 97065-1 | 4.126 | 43.030 | 1.577 | 2.090 | 3.667 | 1.326 |
| Dark Red Norland | 3.38 | 30.71 | 4.29 | 6.44 | 10.73 | 1.50 |
| MN 00177-5 | 14.523 | 41.879 | — | — | — | — |
| MN 02 419 | 7.641 | 49.348 | 2.319 | 4.950 | 7.269 | 2.134 |
| MN 15620 | 5.55 | 53.43 | 2.46 | 1.92 | 4.38 | 0.78 |
| MWTX 2609-4 RU | 9.27 | 43.36 | 1.99 | 5.83 | 7.82 | 2.92 |
| NDTX 4271-5R | 4.765 | 29.728 | 2.299 | 8.016 | 10.316 | 3.487 |
| R. Norkotah | 5.299 | 28.092 | 1.806 | 5.230 | 7.035 | 2.896 |
| Red Pontiac | 4.351 | 24.362 | 5.408 | 7.915 | 13.323 | 1.464 |
| Russet Norkotah | 5.58 | 37.46 | 1.13 | 3.69 | 4.82 | 3.27 |
| STAMPEDE RUSS | 9.682 | 31.608 | 1.148 | 4.469 | 5.617 | 3.892 |
| Average | 10.02 | 41.76 | 2.07 | 5.38 | 7.45 | 2.6 |

¹Specific Activity (SA) = units (mmols Glc formed)mg protein⁻¹hour⁻¹
²mg/g fresh weight (Suc + Glc)

Table 4 summarizes data from 44 genetically diverse potato cultivars and clones having the A-II isozymes of UGPase present and less than one unit of acid invertase enzyme activity. The average basal invertase activity in this group was 0.44 units/hour and total acid invertase activity of 10.21 units/hour. However, this group has lower accumulation of reducing sugar glucose (1.47 mg/g fresh weight) and glucose forming potential (0.49) compared to the similar clones without A-II isozymes of UGPase. The average sucrose content in this group was 2.90 mg/g fresh weight.

TABLE 4
Potato clones with A-II isozyme of UGPase and less
than 1 unit of basal acid invertase activity.

| | Basal | Total | | | Suc + | |
|---|---|---|---|---|---|---|
| Cultivar | AcInv¹ | AcInv¹ | Suc² | Glc² | Glc | GFP |
| A 91814-5 | 0.76 | 23.16 | 1.29 | 1.89 | 3.19 | 1.46 |
| A 97066-42LB | 0.69 | 20.68 | 2.50 | 3.38 | 5.88 | 1.35 |
| AF 2211-4 | 0.967 | 11.973 | 3.240 | 2.030 | 5.270 | 0.627 |
| AF 2291-10 | 0.530 | 6.610 | 5.650 | 1.290 | 6.940 | 0.228 |
| AF 2393-7 | 0.51 | 14.62 | 2.67 | 1.37 | 4.04 | 0.51 |
| AF 2426-1 | 0.345 | 11.676 | 2.750 | 2.860 | 5.610 | 1.040 |
| AF 2431-2 | 0.612 | 22.132 | 3.050 | — | — | 2.007 |
| AOTX 95295-3RU | 0.67 | 31.17 | 4.91 | — | — | — |
| Atlantic | 0.742 | 7.525 | 4.826 | 1.893 | 6.719 | 0.392 |
| ATTX 8823-2W | 0.15 | 19.22 | 2.00 | 1.72 | 3.72 | 0.86 |
| ATTX | 0.81 | 11.78 | 1.49 | — | — | — |
| 98466-5R/W-Y/R | | | | | | |
| ATX 91137-1 RU | 0.62 | 12.98 | 3.76 | 3.39 | 7.15 | 0.90 |
| B 2490-7 | 0.746 | 5.055 | 4.230 | 1.150 | 5.380 | 0.272 |
| CO 95051-7W | 0.104 | 1.325 | 3.667 | 0.610 | 4.277 | 0.166 |
| CO 95051-7W | 0.04 | 18.54 | 3.03 | 1.52 | 4.55 | 0.50 |
| CO 96141-4W | 0.372 | 2.295 | 3.364 | 2.049 | 5.413 | 0.609 |
| Dakota Crisp | 0.76 | 7.59 | 4.43 | 1.48 | 5.91 | 0.33 |
| Dakota Pearl | 0.17 | 1.85 | 4.06 | 0.23 | 4.29 | 0.06 |
| MN 02 524 | 0.65 | 22.69 | 1.16 | 1.49 | 2.66 | 1.29 |
| MN 02 586 | 0.31 | 7.94 | 2.74 | 1.18 | 3.92 | 0.43 |
| MN 02 587 | 0.65 | 24.03 | 2.60 | 1.57 | 4.17 | 0.60 |
| MN 02 588 | 0.569 | 4.223 | 2.053 | 0.787 | 2.841 | 0.383 |
| MSJ 147-1 | 0.752 | 4.557 | 2.136 | 0.111 | 2.247 | 0.052 |
| MSJ 147-1 | 0.93 | 21.49 | 1.37 | 0.41 | 1.78 | 0.30 |
| MSJ 461-1 | 0.26 | 7.75 | 3.02 | 3.17 | 6.19 | 1.05 |
| MSL 007-13 | 0.210 | 2.097 | 2.805 | 1.090 | 3.895 | 0.389 |
| MSN 191-2Y | 0.064 | 0.654 | 3.016 | 0.721 | 3.736 | 0.239 |
| MSN 191-2Y | 0.142 | 0.990 | 1.331 | 0.244 | 1.575 | 0.183 |
| ND 5255-59 | 0.06 | 15.36 | 2.18 | 1.97 | 4.15 | 0.90 |
| ND 5775-3 | 0.877 | 3.354 | 2.383 | 0.947 | 3.331 | 0.398 |
| ND 8304-2 | 0.100 | 5.480 | 1.091 | 0.306 | 1.397 | 0.280 |
| Norchip | 0.49 | 7.49 | 4.90 | 2.37 | 7.28 | 0.48 |
| Norvalley | 0.20 | 10.51 | 1.32 | 1.30 | 2.62 | 0.98 |
| NY 138 | 0.335 | 0.893 | 3.424 | 0.370 | 3.794 | 0.108 |
| NY 139 | 0.413 | 0.803 | 4.359 | 1.084 | 5.443 | 0.249 |
| UNTX 383-3WRE/4 | 0.619 | 5.475 | — | — | — | — |
| VHB 0950-2 | 0.320 | 3.642 | 7.938 | 2.956 | 10.895 | 0.372 |
| W 2133-1 | 0.03 | 21.21 | 2.10 | 1.48 | 3.58 | 0.70 |
| W 2310-3 | 0.25 | 5.91 | 1.30 | 1.56 | 2.86 | 1.20 |
| W 2438-34 | 0.755 | 12.158 | 1.490 | 0.796 | 2.286 | 0.534 |
| W 2717-5 | 0.07 | 1.62 | 3.08 | 0.42 | 3.50 | 0.14 |
| W 4013-1 | 0.118 | 4.322 | 1.109 | 0.179 | 1.288 | 0.161 |
| W 4013-1 | 0.04 | 11.99 | 1.42 | 0.27 | 1.69 | 0.19 |
| Yukon Gold | 0.39 | 12.28 | 3.55 | 3.22 | 6.77 | 0.91 |
| Average | 0.44 | 10.21 | 2.90 | 1.42 | 4.31 | 0.49 |

¹Specific Activity (SA) = units (mmols Glc formed)mg protein⁻¹hour⁻¹
²mg/g fresh weight (Suc + Glc)

Table 5 summarizes data from 17 diverse potato cultivars and clones. The average basal and total acid invertase enzyme activity in this was 1.97 and 16.63 units/hour, respectively. The average glucose content was 2.36 mg/g fresh weight and glucose forming potential of 1.03. This group has average sucrose content of 2.26 mg/g fresh weight.

TABLE 5
Potato clones with A-II isozyme of UGPase and
1-3 units of basal acid invertase activity.

| | Basal | Total | | | Suc + | |
|---|---|---|---|---|---|---|
| Cultivar | AcInv¹ | AcInv¹ | Suc² | Glc² | Glc | GFP |
| A 91814-5 | 1.75 | 11.65 | 1.83 | 1.56 | 3.39 | 0.85 |
| A 95109-1 | 1.95 | 12.80 | 3.24 | 4.04 | 7.28 | 1.25 |
| A 95409-1 | 3.35 | 17.40 | 2.60 | 5.52 | 8.12 | 2.12 |
| AF 2172-56 | 1.07 | 8.36 | 2.09 | 0.60 | 2.69 | 0.29 |
| B 1992-106 | 2.44 | 22.79 | 3.53 | 3.13 | 6.66 | 0.89 |
| B 2477-8 | 2.65 | 19.27 | — | 2.84 | — | 0.38 |
| BNC 48-1 | 3.02 | 19.39 | — | 2.08 | — | 0.19 |
| BNC 49-2 | 1.63 | 7.58 | 2.49 | 1.47 | 3.96 | 0.59 |
| CO 95172-3RU | 1.24 | 30.13 | 2.48 | 4.28 | 6.76 | 1.72 |
| MSJ 036-A | 1.49 | 8.54 | 2.06 | 1.76 | 3.82 | 0.86 |
| ND 5775-3 | 1.21 | 18.54 | 1.71 | 1.39 | 3.10 | 0.81 |
| ND 7799C-1 | 3.27 | 30.83 | 1.60 | 2.31 | 3.92 | 1.44 |
| ND 8305-1 | 1.75 | 1.98 | 2.41 | 0.39 | 2.79 | 0.16 |
| Snowden | 1.97 | 15.86 | 1.37 | 1.19 | 2.57 | 0.87 |
| Snowden | 1.23 | 23.88 | 1.51 | 1.89 | 3.40 | 1.25 |
| W 2324-1 | 2.41 | 30.13 | 1.41 | 1.94 | 3.35 | 1.38 |
| Yukon Gold | 1.05 | 3.60 | 3.55 | 3.22 | 6.77 | 0.91 |
| Average | 1.97 | 16.63 | 2.26 | 2.33 | 4.57 | 1.03 |

¹Specific Activity (SA) = units (mmols Glc formed)mg protein⁻¹hour⁻¹
²mg/g fresh weight (Suc + Glc)

Table 6 summarizes data from 12 genetically diverse potato cultivars and clones. The average basal and total acid invertase enzyme activity was 8.28 and 29.88 units/hour, respectively. Although these clones have high acid invertase enzyme activity, they accumulated relatively lower levels of reducing sugar (3.40 mg/grams fresh weight) and glucose forming potential of 1.93 compared to the similar potato clones without A-II isozymes of UGPase.

TABLE 6
Potato clones with A-II isozymes of UGPase and more
than 3 units of Basal acid invertase activity.

| | Basal | Total | | | Suc + | |
|---|---|---|---|---|---|---|
| Cultivar | AcInv¹ | AcInv¹ | Suc² | Glc² | Glc | GFP |
| A 9305-10 | 4.80 | 25.70 | 2.72 | 2.88 | 5.60 | 1.06 |
| AF 2314-1 | 3.92 | 19.53 | 1.23 | 2.81 | 4.04 | 2.28 |
| AF 2376-5 | 4.09 | 21.24 | 2.03 | 1.92 | 3.95 | 0.95 |
| AOTX 95265-3RU | 10.13 | 43.19 | 0.97 | 4.38 | 5.35 | 4.52 |
| ATTX 95490-2W | 6.77 | 23.96 | 0.41 | 8.03 | 8.44 | 19.69 |
| Highland Russ | 32.12 | 57.71 | 0.19 | 5.47 | 5.66 | 29.02 |
| MN 02 582 | 4.01 | 5.76 | 1.64 | 0.39 | 2.03 | 0.24 |
| MN 02 678 | 4.43 | 36.57 | 1.64 | 0.84 | 2.48 | 0.51 |
| NDA 5507-3Y | 12.26 | 24.61 | 1.17 | 1.88 | 3.05 | 1.61 |
| Russet Burbank | 5.18 | 42.09 | 2.34 | 4.54 | 6.88 | 1.94 |
| Shepody | 3.19 | 15.26 | 3.76 | 3.85 | 7.62 | 1.02 |
| TXA 549-1 RU | 8.46 | 42.98 | 3.04 | 3.83 | 6.87 | 1.26 |
| Average | 8.28 | 29.88 | 1.76 | 3.40 | 5.16 | 1.93 |

¹Specific Activity (SA) = units (mmols Glc formed)mg protein⁻¹hour⁻¹
²mg/g fresh weight (Suc + Glc)

### Basal Invertase Activity and Reducing Sugar Accumulation

Table 7 summarizes data showing that potato cultivars with low levels of basal acid invertase enzyme activity accumulated less reducing sugar when stored for six months. Potato clones with 0.46 units of average basal acid invertase activity accumulated 1.70 mg/g fresh weight glucose. In contrast, potato clones with 2.10 units of basal acid invertase activity accumulated 3.00 mg/g fresh weight of glucose, while potato clones with 10.02 units of basal acid invertase activity accumulated 5.38 mg/g fresh weight of glucose.

The presence of A-II isozymes of enzyme UGPase further decreased glucose accumulation. Potato clones having A-II isozymes of UGPase and 0.44 units of basal acid invertase enzyme activity accumulated 1.47 mg/g fresh weight of reducing sugar glucose during six months of storage. Potato clones having A-II isozymes of UGPase and 1.97 units of basal acid invertase enzyme activity accumulated 2.36 mg/g fresh weight glucose during six months of storage, while potato clones having A-II isozymes of UGPase and 8.28 units of basal acid invertase enzyme activity accumulated and 3.40 mg/g fresh weight glucose during six months of storage.

TABLE 7
Average total sugar formed in potato clones with and without A-II Isozymes.

| | A-II isozyme of UGPase enzyme | | | | A-II isozyme of UGPase enzyme | | | |
|---|---|---|---|---|---|---|---|---|
| | present | | | | absent | | | |
| AcInv SA¹ | | Basal | Ave. | | | Basal | Ave. | |
| Range | n³ | AcInv¹ | Glc³ | GFP⁴ | n | AcInv | Glc | GFP³ |
| Less than 1 unit | 44 | 0.44 | 1.47 | 0.60 | 40 | 0.46 | 1.70 | 0.66 |
| Between 1-3 units | 17 | 1.97 | 2.36 | 0.92 | 24 | 2.10 | 3.00 | 1.50 |
| More than 3 units | 13 | 8.28 | 3.40 | 5.34 | 15 | 10.02 | 5.38 | 5.01 |

Clones were stored for 6 months at 5.5° C.
¹Specific Activity (SA) = units (mmols Glc formed)mg protein⁻¹hour⁻¹
²mg/g fresh weight
³number of clones
⁴Glucose Forming Potential (Glucose/Sucrose)

### Basal Invertase Activity and Glucose Forming Potential

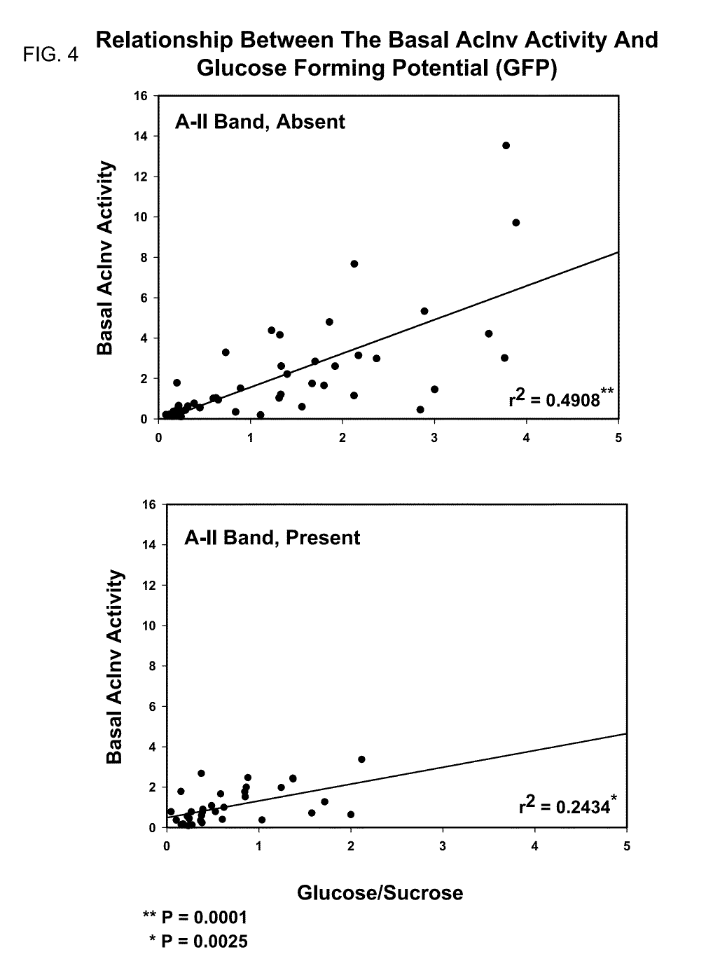

Glucose forming potential (GFP) represents the ratio of reducing sugar glucose and total sucrose in the cell. Acid invertase enzyme converts sucrose into reducing sugars glucose. Therefore, GFP could be used and indirect reflection of acid invertase enzyme activity in the cell. As shown in Table 7, potato clones with average basal acid invertase activity of 0.46, 2.10, and 10.02 units recorded GFP of 0.66, 1.50, and 5.01, respectively. Combined analysis of all the potato clones showed a positive correlation between basal acid invertase activity and GFP (FIG. 4A), but did not show a similar correlation with the level of reducing sugar glucose (FIG. 4B). Total acid invertase activity, however, revealed a positive correlation with both GFP and reducing sugar glucose (Table 9).

TABLE 9
Association of enzyme activity with sugar formation
in diverse potato clones

| | Rsqr Value | | | |
|---|---|---|---|---|
| Parameter | Glucose | Sucrose | Total Sugar | Glc Forming Potential |

Pooled Data (n = 143)

| | | | | |
|---|---|---|---|---|
| Basal AcInv | 0.2392 | 0.0930 | 0.0201 | 0.7590** |
| Total AcInv | 0.3091 | 0.1154 | 0.0625 | 0.2582 |

Potato clone without A-II isozymes of UGPase (n = 78)

| | | | | |
|---|---|---|---|---|
| Basal AcInv | 0.1308 | 0.0850 | 0.0189 | 0.9055** |
| Total AcInv | 0.2735 | 0.1244 | 0.0661 | 0.2876 |

Potato clones with A-II isozymes of UGPase (n = 65)

| | | | | |
|---|---|---|---|---|
| Basal AcInv | 0.2335 | 0.1170 | 0.0198 | 0.6655* |
| Total AcInv | 0.3313 | 0.1312 | 0.0252 | 0.2706 |

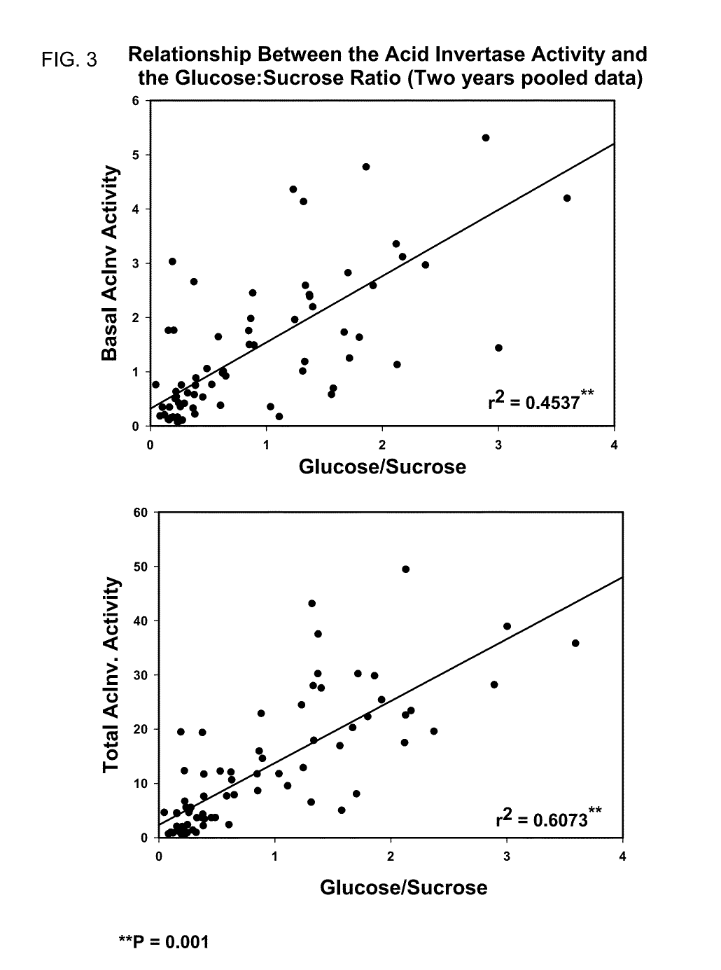

Regardless of the basal level of acid invertase activity, a combined analysis of all the potato clones without A-II isozymes of UGPase showed a positive correlation with basal acid invertase activity (FIG. 3A), but not with glucose, sucrose, or total sugar concentration in the cell (Table 9.). Total acid invertase activity did not show any significant correlation with sugars. Similar patterns were recorded for the potato clones with A-II isozymes of UGPase (FIG. 3B and Table 9).

### Contribution of A-II Isozymes of UGPase to Total Sugar Accumulation

Total sugar in cold-stored potato tuber represents the amount of sucrose and reducing sugar glucose plus fructose. As shown in Table 8, potato clones without A-II isozymes of UGPase and varying levels of basal acid invertase activity accumulated average 4.67, 5.30, and 7.45 mg/g fresh weight total sugar. Basal acid invertase level showed some effect on total sugar status of the tubers. Potato clones having A-II isozymes of UGPase and varying levels of basal acid invertase activity recording average total sugar accumulation of 4.31, 4.57, and 4.89 mg/g fresh weight.

TABLE 8
Average total sugar formed in potato clones
with and without A-II Isozymes.

| | Total Sugar Formed² | | | |
|---|---|---|---|---|
| AcInv SA¹ Range | n³ | No A-II isozymes | n³ | A-II isozymes |
| Less than 1 units | 40 | 4.67 | 44 | 4.31 |
| Between 1-3 units | 24 | 5.30 | 17 | 4.57 |
| More than 3 units | 15 | 7.45 | 13 | 4.89 |

Clones were stored for 6 months at 5.5° C.
¹Specific Activity (SA) = units (mmols Glc formed) mg protein⁻¹ hour⁻¹
²mg/g fresh weight (Suc + Glc)
³number of clones

As used herein the term “and/or” means one or all of the listed elements or a combination of any two or more of the listed elements; the terms “comprises” and variations thereof do not have a limiting meaning where these terms appear in the description and claims; unless otherwise specified, “a,” “an,” “the,” and “at least one” are used interchangeably and mean one or more than one; and the recitations of numerical ranges by endpoints include all numbers subsumed within that range (e.g., 1 to 5 includes 1, 1.5, 2, 2.75, 3, 3.80, 4, 5, etc.).

In the preceding description, particular embodiments may be described in isolation for clarity. Unless otherwise expressly specified that the features of a particular embodiment are incompatible with the features of another embodiment, certain embodiments can include a combination of compatible features described herein in connection with one or more embodiments.

For any method disclosed herein that includes discrete steps, the steps may be conducted in any feasible order. And, as appropriate, any combination of two or more steps may be conducted simultaneously.

The present invention is illustrated by the following examples. It is to be understood that the particular examples, materials, amounts, and procedures are to be interpreted broadly in accordance with the scope and spirit of the invention as set forth herein.

### EXAMPLES

### Reagents

All chemicals, reagents and enzymes, unless otherwise stated, were purchased from Sigma Chemical Company (St. Louios, Mo.). PVDF membranes, all molecular weight standards, and protein assay dyes were obtained from BioRad Laboratories, Inc. (Hercules, Calif.).

### Plant Material

Eighty-six potato cultivars (Solanum tuberosum L.) were planted May 15, 2006 in Grand Forks, N. Dak. Cultivation, plant fertilization, and disease control followed local commercial practice. Potatoes were harvested mid-September and placed into 38° F., 40° F., 42° F., or 45° F. storage at the USDA-ARS Potato Research Worksite in East Grand Forks, Minn. Following three months of storage, tubers were analyzed using the Vacuolar Acid Invertase (basal and total) activity assay and non-denaturing PAGE activity gel.

### Grinding Tissue Under Liquid Nitrogen

Fresh tissues were frozen in liquid nitrogen and ground in a liquid nitrogen mill (Spex 6750, Spex SamplePrep, Metuchen, N. J.). Around 5 grams of fresh tissue from 2-3 tubers were cut and immediately frozen into liquid nitrogen. Frozen tissue was put into the liquid nitrogen mill 5 mL capacity chamber for making powder. For grinding, three cycles of one minute each were used with the rate of 10. The setting were T1=1 min, T2=2, T3=3 min, Rate=10. Between every cycle there was a one minute gap. After grinding, the frozen powder was immediately transferred to the 5 mL scintillation vials and stored at −80° C.

### Enzyme Extraction and Desalting

All steps were conducted at 4° C. For the enzyme extraction, 1 g of the frozen potato tuber powder was mixed with 1 mL of the extraction buffer containing 50 mM Hepes, pH 7.5, 15 mM MgCl₂, 2 mM EDTA, 2 mM dithiothreitol (DTT), 10% v/v glycerol and 2% poly(venylpoly-pyrrolidone) (PVPP). The tubes were kept on ice for 10 minutes. Following occasional shaking for 10 minutes, the tubes were centrifuged for 20 minutes at 4° C. and 23,000×g. The supernatant was collected for vacuolar acid invertase enzyme activity assay, protein estimation and non-denaturing PAGE, after desalting. The supernatant was desalted using a desalting column (Zeba, 2 mL capacity, Pierce, Thermo Fisher Scientific Inc., Rockford, Ill.). The desalting columns were pre-equilibrated with desalting buffer containing 50 mM Hepes, pH 7.5, 15 mM MgCl₂, 2 mM EDTA and 2 mM dithiothreitol (DTT).

### Vacuolar Acid Invertase Assay

The VAcInv activity was measured in two-step process. The first step was the hydrolysis of sucrose by the VAcInv in crude extract to form glucose and fructose. The second step was to measure the amount of glucose by Sumner's reagent.

In the first step, the reaction mixture (100 μL) contained 60 mM phosphate-citrate buffer, pH 5.0, and various amounts of crude extract. The reaction was initiated by adding 40 mM freshly prepared sucrose solution. For every sample a blank was prepared by heat killing enzyme at 94° C. for three minutes. The tubes were incubated at 37° C. for 60 minutes in a thermocycler. The formation of reducing sugars was terminated by increasing the temperature to 94° C. for three minutes. Each reaction mixture was centrifuged for five minutes at 13000 rpm. The supernatant was transferred to fresh 0.6 mL Eppendorf tube.

In the second step, 100 μL of Sumner's reagent (0.01% 3,5-dintrosalicylic acid, 1.6% NaOH and 30% potassium sodium tartrate) was added to each tube. All the tubes were incubated at 94° C. for 10 minutes and then chilled to 4° C. An aliquot of 150 μL from each tube was removed, then placed into an ELISA plate to record absorbance at 550 nm. The enzyme activity was expressed in μmols of glucose formed per hour per mg of protein.

### Glucose Standard Curve

In order to calculate the amount of reducing sugars in the samples, a series of glucose dilutions were used as standards. A series of glucose standards from 0.5 mM to 4.5 mM concentration were made by serial dilution. The reaction mixture consisted of 100 μL of glucose standard in triplicate and 100 μL of Sumner's reagent. All the tubes were incubated at 94° C. for 10 minutes and then chilled to 4° C. An aliquot of 150 μL from each tube was removed, then placed into an ELISA plate to record absorbance at 550 nm. The absorbance was plotted against the glucose concentration.

Removal of the inhibitor was achieved by rapid vortexing of 100 uL aliquots in 0.2 mL microcentrifuge tubes for 20 minutes at room temperature. The size of aliquot, vortexing speed, and length of vortexing treatment were optimized for a VortexGenie II (Scientific Industries, Inc., Bohemia, N.Y.). Foamed aliquots were immediately assayed for invertase activity; however, no re-association of the inhibitor was apparent within four hours of vortexting.

### Enzyme Activity Assay Standardization

This protocol was standardized for linearity of reaction over enzyme dilution (protein concentration) and reaction time. Two potato cultivars Russet Burbank (high invertase activity) and Dakota Pearl (low invertase activity) with wide variation in their invertase activity were selected from 40° F. storage. Desalting columns (Zeba, 2 mL capacity, Pierce, Thermo Fisher Scientific Inc., Rockford, Ill.) were used to remove any free reducing sugar in the crude extract. To destroy the invertase inhibitor activity, samples were vortexed at maximum speed for 20 minutes.

(a) Reaction Linearity Over Protein Dilution:

We used various volumes of desalted crude extract for the assay. The reaction mixture consisted of 60 mM phosphate-citrate buffer, pH 5.0, and the desalted crude extract from 5 μL to 70 μL. The reaction was initiated by the addition of 40 mM freshly prepared sucrose solution. For every sample a blank was prepared by heat killing enzyme at 94° C. for three minutes. The tubes were incubated at 37° C. for 60 minutes in thermocycler. The formation of reducing sugars was terminated by increasing the temperature to 94° C. for three minutes.

(b) Reaction Linearity Over Time:

In order to find the optimum reaction time, 50 μL crude extract was used for every reaction. Reactions were carried at 37° C. for various time intervals of 15 minutes to 240 minutes.

### Sugar Estimation

200 g of fresh tuber tissue was homogenized at 4° C. in an Acme Jucirator, model 6001 (Waring Co., Lemoyne, Pa.). This tissue was washed with two aliquots (100 and 50 mL, respectively) of 50 mM Na-phosphate buffer, pH 7.5. The extract was diluted to 275 mL with buffer and 10 mL aliquots in duplicate were frozen for sugar analysis. Sugars (Glc and Suc) were analyzed using a YSI model 2000 Industrial Analyzer (Yellow Springs Instruments Co., Inc., Yellow Springs, Ohio). The concentration of sugar was expressed in mg per gram fresh weight.

### Protein Determination

Protein content of all the samples was determined using the dye-binding method described in Bradford, M M. 1976. Anal Biochem 72:248-254. Bovine gamma-globulin was used as the protein standard.

### Nondenaturing PAGE

A native polyacrylamide gel was run with 1 mm thick slab gels containing 7.5% acrylamide. Previous purified UGPase from cultivar Norchip (Sowokinos et al. 1993. Plant Physiol 101:1073-1080) was used as standard protein. Proteins were visualized using silver stain.

### UGPase Activity Gels

UGPase activity was detected using a 1% low-melting agarose gel overlaid with a nondenaturing protein gel. (Sowokinos et al. 1997. Plant Physiol 113:511-517). As the temperature of the melted agarose decreased to 45° C., 20 mL of melted agarose was mixed with 20 mL of reagent solution to give a final concentration of 250 mM Tris-HCl, pH 8.5, 10 mM MgCl₂, 5 mM PPi, 4 mM UDP-Glc, 0.5 mM NAD⁺, 20 μmol Glc-1,6-diphosphate, PGM (1 unit/mL), Glc-6-P dehydrogenase (Leuconostoc mesenteroides) (1 unit/mL), 3-(4,5-dimethylthiazol-2-yl)-2,5-diphenyltetrazolium bromide (0.4 mg/mL), and phenazine methosulfate (75 μg/mL). After the agarose mixture was solidified and over layered with a nondenaturing protein gel, the reaction was continued for 30 minutes at room temperature in the dark. The reaction was stopped my removing the protein gel and allowing the agarose slab to dry on paper (WHATMAN 3MM, GE Healthcare Bio-Sciences, Piscataway, N.J.).

The complete disclosure of all patents, patent applications, and publications, and electronically available material (including, for instance, nucleotide sequence submissions in, e.g., GenBank and RefSeq, and amino acid sequence submissions in, e.g., SwissProt, PIR, PRF, PDB, and translations from annotated coding regions in GenBank and RefSeq) cited herein are incorporated by reference in their entirety. In the event that any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present invention. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

1. A method comprising:
analyzing a plurality of potatoes for at least one cold storage indicator; and
storing at least a portion of the plurality of potatoes for a predetermined time at a predetermined temperature if the cold storage indicator value is a predetermined value.

2. The method of claim 1 wherein the predetermined time is no more than 270 days.

3. The method of claim 1 wherein the predetermined temperature is no more than 45° F.

4. The method of claim 1 wherein analyzing the plurality of potatoes for at least one cold storage indicator comprises detecting the cold storage indicator in a sample obtained from at least one potato of the plurality of potatoes.

5. The method of claim 1 wherein the cold storage indicator is at least one of:
acid invertase, or
A-II isozyme of UGPase.

6. The method of claim 5 wherein the cold storage indicator comprises acid invertase and the predetermined value comprises no more than 3 enzyme units (μmols glucose formed/mg protein/hour).

7. The method of claim 6 wherein the predetermined value comprises no more than 1 enzyme unit.

8. The method of claim 6 wherein detecting the cold storage indicator comprises performing an assay measuring acid invertase enzymatic activity.

9. The method of claim 5 wherein the cold storage indicator comprises A-II isozyme of UGPase and the predetermined value comprises qualitative detection after electrophoresis on a 7.5% acrylamide nondenaturing gel.

10. The method of claim 1 wherein the stored potatoes possess an average glucose forming potential of no more than 1.50.
